(19) United States
(12) Patent Application Publication
(10) Pub. No.: US 2019/0179013 A1
(43) Pub. Date: Jun. 13, 2019

(54) METHOD FOR A LIDAR DEVICE FOR DETECTING A CONCEALED OBJECT

(71) Applicant: Robert Bosch GmbH, Stuttgart (DE)

(72) Inventor: Ingo Ramsteiner, Leonberg (DE)

(21) Appl. No.: 16/212,151

(22) Filed: Dec. 6, 2018

(30) Foreign Application Priority Data
Dec. 8, 2017 (DE) 102017222258.1

(51) Int. Cl. G01S 17/02; G01S 17/93

(52) U.S. Cl. CPC G01S 17/026; G01S 17/936

(57) ABSTRACT

A method of a LIDAR device for detecting a concealed object concealed from the visual field of the LIDAR device by an obstacle includes: initially emitting a first radiation in a predefined direction for illuminating a scattering surface, receiving a reflection of the first radiation, and ascertaining at least one value of the received reflection of the first radiation; and subsequently, based on the at least one value, emitting detection radiation in the predefined direction for illuminating and scattering on the scattering surface, which is situated in a visual field of the concealed object, receiving a reflection of the detection radiation from an image area to which the detection radiation has been reflected from the concealed object, and detecting the concealed object based on the received detection radiation.

### CROSS-REFERENCE TO RELATED APPLICATIONS

The present application claims priority under 35 U.S.C. § 119 to DE 10 2017 222 258.1, filed in the Federal Republic of Germany on Dec. 8, 2017, the content of which is hereby incorporated by reference herein in its entirety.

### FIELD OF THE INVENTION

The present invention relates to a method for a LIDAR device for detecting a concealed object, a computer program that is configured for carrying out the steps of the method, a machine-readable memory medium on which the computer program is stored, and a LIDAR device for detecting a concealed object.

### BACKGROUND

A method and a device for detecting position information of a target object that is not situated in the visual field of the device is known from WO 2016/063028 A1. The device includes an illumination device for illuminating a scattering surface situated in a viewing direction of the target object, scattered radiation having been scattered by the scattering surface. The device also includes a detection device for detecting reflected radiation. The reflected radiation is the scattered radiation that has been reflected from the target object into the visual field of the detection device. The device also includes a processing device for computing the position information based on the detected reflected radiation.

Accordingly, the illumination device emits light pulses which return to the detection device via three diffuse scattering operations (surface, object, surface). Since this is normally only an extremely small portion of the emitted light pulses, high pulse intensities of the emitted light pulses are necessary for reliable detection.

### SUMMARY

The present invention is directed to a method for a LIDAR device for detecting a concealed object, the concealed object in the visual field of the LIDAR device being concealed by an obstacle. The method includes the step of emitting detection radiation in a predefined direction for illuminating a scattering surface, using at least one transmitting unit. The scattering surface is situated in a visual field of the concealed object. The emitted detection radiation is scattered on the scattering surface. The method includes the further step of receiving reflected detection radiation from an image area using a receiving unit. The reflected detection radiation is the detection radiation that has been reflected from the concealed object to the image area. The method includes the further step of detecting the concealed object based on the received detection radiation, using at least one evaluation unit.

According to the present invention, the method includes further, chronologically preceding steps. The method includes the chronologically preceding step of emitting a first radiation in the predefined direction using at least one transmitting unit for illuminating the scattering surface. The method also includes the chronologically preceding step of receiving a first radiation using a receiving unit. The method also includes the chronologically preceding step of ascertaining at least one value of the received first radiation using the evaluation unit.

The emitted detection radiation can be electromagnetic radiation. The emitted detection radiation can be laser radiation. In particular, the emitted detection radiation can be pulsed laser radiation. The emitted first radiation can be electromagnetic radiation. The emitted first radiation can be laser radiation. In particular, the emitted first radiation can be pulsed laser radiation. The transmitting unit can include a laser device. The laser device can be an individual laser. An individual laser can be a laser diode, for example. The laser device can be a plurality of individual lasers. The transmitting unit can include a pulsed or an unpulsed laser. A pulsed laser can emit laser pulses at a predefined frequency. The transmitting unit for emitting the detection radiation can be the same transmitting unit as the transmitting unit for emitting the first radiation. The transmitting unit for emitting the detection radiation can be different from the transmitting unit for emitting the first radiation.

The received first radiation can have been scattered on the scattering surface. The received first radiation can have additionally been diffusely reflected on the scattering surface. The received first radiation can also have been reflected on an unconcealed object in the visual field of the LIDAR device. The received first radiation can also have been directionally reflected on an unconcealed object in the visual field of the LIDAR device.

For high temporal resolution, it is advantageous when the receiving unit can be operated in a time-correlated single photon counting (TCSPC) mode. The receiving unit can include a time-resolving light detector. The receiving unit can include a time-resolving light detector array. The receiving unit can include a single photon avalanche diode (SPAD) matrix, for example. The receiving unit for receiving the reflected detection radiation can be the same receiving unit as the receiving unit for receiving the first radiation. The receiving unit for receiving the reflected detection radiation can be different from the receiving unit for receiving the first radiation.

The evaluation unit can be a signal processing unit. The evaluation unit can be configured for carrying out, based on the received detection radiation, an evaluation according to a time-of-flight method. The evaluation unit can be configured for carrying out, based on the received first radiation, an evaluation according to a time-of-flight method. The evaluation unit for detecting the concealed object can be the same evaluation unit as the evaluation unit for ascertaining at least one value of the received first radiation. The evaluation unit for detecting the concealed object can be different from the evaluation unit for ascertaining at least one value of the received first radiation.

The advantage of the present invention is that the method for recognizing an object that is concealed by an obstacle can be used in road traffic, for example, without endangering the safety of the other road users. The method can be advantageous for use in a vehicle, for example. The LIDAR device can be part of a vehicle, for example. The method can be advantageous for use in a semiautonomous vehicle or in an autonomous vehicle. Objects that enter the detection field of the sensor devices of the vehicle from the side can potentially be recognized during travel. The objects can be recognized at a point in time when they are still concealed by an obstacle. The concealed objects can be recognized even before they actually enter the detection field of the sensor devices of the vehicle. Thus, more time is obtained for countermeasures (braking, seat belt tensioning, activation of the airbag, etc.).

In an example embodiment of the present invention, it is provided that the method includes the further, chronologically preceding step of comparing the at least one ascertained value of the received first radiation to at least one predefined value using the evaluation unit. The step of emitting the detection radiation is dependent on the comparison.

For recognizing a concealed object, it may be necessary to emit detection radiation having high pulse intensities where the detection radiation is no longer be safe for the eyes. An advantage of this embodiment is that, due to the chronologically preceding steps, a method is provided in which the emission of the detection radiation can be linked to conditions that make it unlikely that other road users will be harmed. Thus, an unconcealed object in a visual field of the LIDAR device can be recognized via the comparison. One condition, for example, can be that detection radiation having high pulse intensity is emitted only when no unconcealed object is recognized in the visual field of the LIDAR device.

In an example embodiment of the present invention, it is provided that the at least one ascertained value of the received first radiation is a value of an intensity of the received first radiation. The at least one ascertained value of the received first radiation can also include a value of the distance of an unconcealed object in the visual field of the LIDAR device. For example, at least two values of the received first radiation can also be ascertained. A first value can be a value of the intensity of the received first radiation. A second value can be a value of the distance of an unconcealed object in the visual field of the LIDAR device.

An unconcealed object can, for example, be a moving object in the visual field of the LIDAR device. A moving object can be a road user, for example. Another road user could possibly be harmed by the emission of the detection radiation. An unconcealed object can also be a nonmoving object in the visual field of the LIDAR device. A nonmoving object can be reflective, for example. Thus, automotive sheet metal, a rearview mirror, or a car window can be reflective. A nonmoving object can also be directionally reflective, for example. This can be the case with wet conditions or with glistening surfaces. The emitted detection radiation can be reflected on the nonmoving object in such a way that it endangers road users.

An advantage of this embodiment is that an unconcealed object in the visual field of the LIDAR device can be reliably recognized in the chronologically preceding steps. The risks described above can be minimized.

In an example embodiment of the present invention, it is provided that the power of the emitted detection radiation is different from the power of the emitted first radiation. The difference can be in the range of one to three orders of magnitude. Additionally or alternatively, it is provided that the wavelength of the emitted detection radiation is different from the wavelength of the emitted first radiation.

An advantage of this embodiment is that the eye safety of other road users can be ensured. The eye safety of a transmitting unit is stipulated by regulations provided for this purpose. If the transmitting unit includes a laser source, for example the laser safety standard IEC 608251 Ed. 3 is applicable. One variable specifying the eye safety of a laser can accordingly be the power of the laser or the wavelength of the laser. In addition, a correction factor can optionally be taken into account. The correction factor can take the extension of the laser source, for example, into account. Thus, for example, the power of the emitted first radiation of a predefined wavelength can be lower than the power of the emitted detection radiation at the same wavelength. Thus, for example, the intensities of the laser pulses of the emitted first radiation of a predefined wavelength can be less than the intensities of the laser pulses of the emitted detection radiation at the same wavelength. In particular, the emitted first radiation can be safe to the eyes.

In an example embodiment of the present invention, it is provided that the method includes the further, chronologically preceding steps of detecting the surroundings and recognizing obstacles and an area concealed by the obstacles, based on the detected surroundings. The step of emitting the first radiation is dependent on the recognition.

Detecting the surroundings and recognizing obstacles can take place using the LIDAR device itself. Alternatively or additionally, the detection of the surroundings and the recognition of obstacles can take place using at least one further sensor device that is installed in a vehicle.

An advantage of this embodiment is that it can initially be checked whether obstacles are present in the surroundings of the LIDAR device that can potentially conceal objects. The emission of the first radiation can be dependent on the recognition in such a way that first radiation is emitted only when such an obstacle is recognized. The emission of the detection radiation can be dependent on the recognition in such a way that detection radiation is emitted only when such an obstacle is recognized. As a result, the method is applied only when necessary.

In addition, an example embodiment of the present invention is directed to a computer program configured for carrying out the described method steps. In addition, an example embodiment of the present invention is directed to a machine-readable memory medium on which the described computer program is stored.

An example embodiment of the present invention is directed to a LIDAR device for detecting a concealed object. The concealed object in the visual field of the LIDAR device is concealed by an obstacle. The LIDAR device includes at least one transmitting unit for emitting detection radiation in a predefined direction for illuminating a scattering surface. The scattering surface is situated in a visual field of the concealed object. The emitted detection radiation is scattered on the scattering surface. The LIDAR device also includes at least one receiving unit for receiving reflected detection radiation from an image area. The reflected detection radiation is the detection radiation that has been reflected from the concealed object to the image area. The LIDAR device also includes at least one evaluation unit for detecting the concealed object based on the received detection radiation.

According to the present invention, the at least one transmitting unit is also designed for emitting a first radiation in the predefined direction for illuminating the scattering surface. The at least one receiving unit is also designed for receiving a first radiation that is scattered on the surface. The at least one evaluation unit is also designed for ascertaining at least one value of the received first radiation.

In an example embodiment, the LIDAR device includes a first transmitting unit and at least one second transmitting unit. The first transmitting unit is designed for emitting the detection radiation, and the second transmitting unit is designed for emitting the first radiation.

In an example embodiment, the LIDAR device includes a first receiving unit and at least one second receiving unit. The first receiving unit is designed for receiving the reflected detection radiation, and the second receiving unit is designed for receiving the first radiation that is scattered on the surface.

Exemplary embodiments of the present invention are explained in greater detail below with reference to the appended drawings. Identical or functionally equivalent elements are denoted by the same reference numerals in the figures.

### BRIEF DESCRIPTION OF THE DRAWING

FIG. 1 is a flowchart that illustrates a method according to an example embodiment of the present invention.

FIGS. 2A-2B illustrate use of a method according to an example embodiment of the present invention.

FIG. 3 illustrates a LIDAR device according to an example embodiment of the present invention.

### DETAILED DESCRIPTION

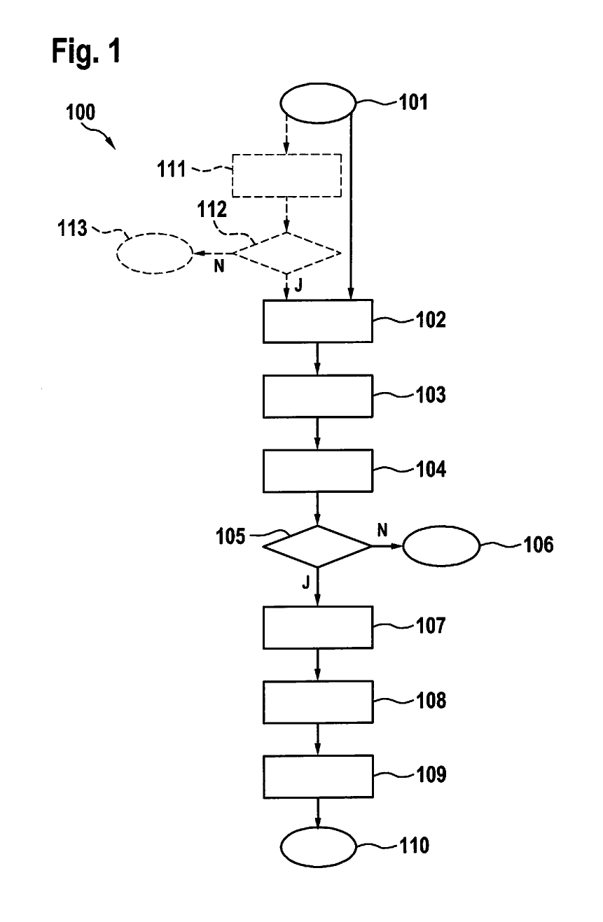

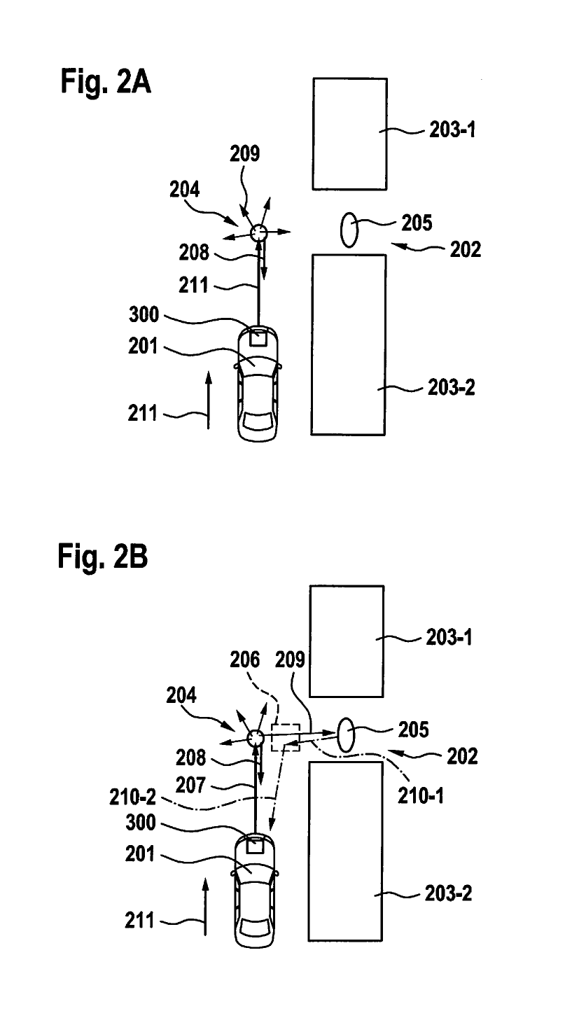

FIG. 1 illustrates example method 100 for a LIDAR device for detecting a concealed object. FIGS. 2A-2B illustrates an example application of the method in a vehicle. FIG. 2A illustrates the first part of method 100 up to and including step 106. The first part of method 100 can optionally also include steps 111, 112, and/or 113. FIG. 2B illustrates the second part of method 100 from step 107 up to and including step 110.

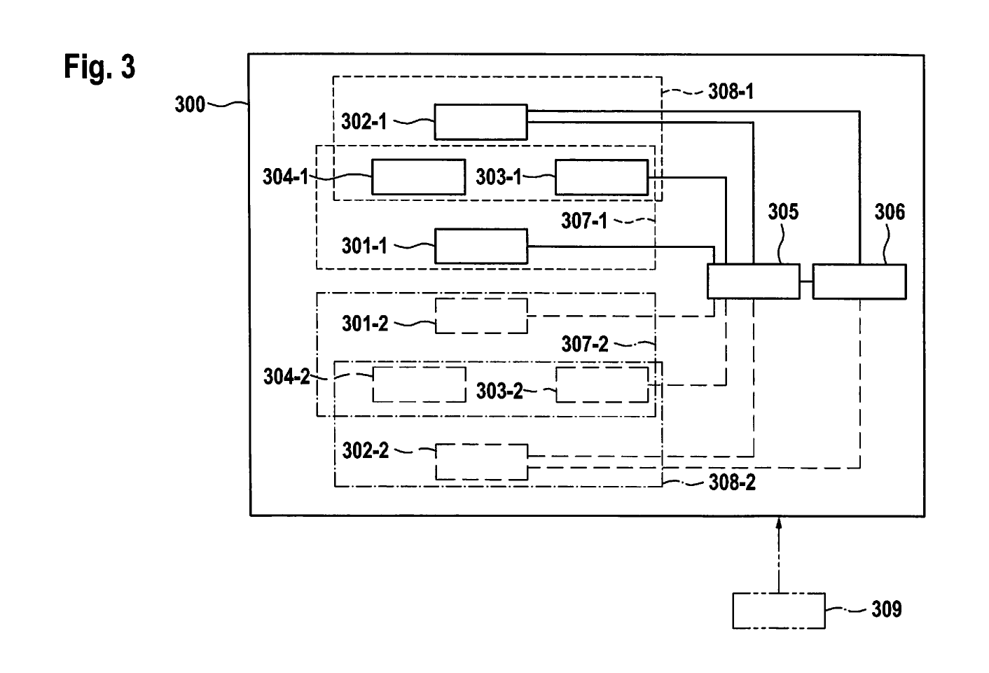

FIG. 2A shows vehicle 201, which includes a LIDAR device 300, as described further below with reference to FIG. 3, for detecting a concealed object. Vehicle 201 moves along travel direction 211, for example. Obstacles 203-1 and 203-2 are situated in the surroundings of the vehicle. Obstacles 203-1 and 203-2 can also be nonmoving objects, for example, that are situated in the visual field of LIDAR device 300. Obstacles 203-1 and 203-2 can each be a house or a row of houses, for example. Obstacles 203-1 and 203-2 can also alternatively each be a vehicle, for example. The two obstacles 203-1 and 203-2 conceal area 202 from the LIDAR device. A concealed object 205 can be situated in area 202. Concealed object 205 can be another road user, for example. Concealed object 205 can be a pedestrian, for example. Concealed object 205 can be another vehicle, for example.

Method 100 shown in FIG. 1 starts in step 101. A first radiation is emitted in a predefined direction using at least one transmitting unit of the LIDAR device in step 102. This first radiation is illustrated by arrow 211 in FIG. 2A. The emission in a predefined direction can take place, for example, in the direction of a predefined area. In FIG. 2A the predefined area is area 204. This area can be a punctiform area. When the LIDAR device is scanning, area 204 can also have an extension that is predefined by one or multiple scanning angles. This area can be a circular area, for example. This area can be a quadrangular area, for example. Emitted first radiation 211 can be scattered from a surface in the visual field of LIDAR device 300. The surface can be, for example, a road surface in area 204. Emitted first radiation 211 can be scattered from a surface in the visual field of LIDAR device 300. Emitted first radiation 211 can be diffusely reflected from a surface in the visual field of LIDAR device 300. The scattering surface can be a road surface, for example. This is illustrated in FIG. 2A by arrows 209 diffusely emanating in various directions. Separately marked arrow 208 represents radiation that is scattered or reflected back in the direction of LIDAR device 300. Due to the emission of the first radiation in a predefined direction, in particular a predefined area, the distance of the predefined area from the LIDAR device can also be predefined. The value of this predefined distance can be used as a predefined value in the further method.

According to method 100 in FIG. 1, the first radiation scattered and/or reflected on the surface in step 103 is received using a receiving unit. For example, the radiation depicted by arrow 208 can be received. At least one value of the received first radiation is ascertained in step 104 of method 100 using an evaluation unit. The at least one value can be a value of the distance of an unconcealed object in the visual field of the LIDAR device. The evaluation unit can ascertain the distance according to a time-of-flight method. Alternatively, the at least one value can be a value of an intensity of the received first radiation. Two values can be ascertained, where a first value can be a value of the distance of an unconcealed object in the visual field of the LIDAR device, and a second value can be a value of the intensity of the received first radiation.

A tolerance range can be predefined for the predefined value. The at least one ascertained value is compared to at least one predefined value in step 105. The value of the distance of an unconcealed object in the visual field of the LIDAR device is compared to a predefined value. The predefined value of the distance may, as described above, be specified from the predefined direction, in particular from the predefined area, in which the first radiation is emitted. Alternatively or additionally, the value of the intensity of the received first radiation is compared to a predefined value. The predefined value of the intensity of the received first radiation can be specified by the operating parameters of the transmitting unit. The predefined value of the intensity of the received first radiation can be specified by the intensity of the laser pulses of the first radiation that are emitted using the transmitting unit.

If it is determined in step 105 that the at least one ascertained value differs from the predefined value, the method can be aborted in step 106. In an example, if it is determined in step 105 that the difference of the at least one ascertained value from the predefined value is so great that the ascertained value is outside the tolerance range of the predefined value, the method can be aborted in step 106. If the comparison shows, for example, a value of the distance that is outside the tolerance range of the predefined value of the distance, it is to be assumed that an unconcealed object is in the beam path of the first radiation. An unconcealed object can result in particular in the ascertained value of the distance being less than the predefined value of the distance. Since the emission of detection radiation according to step 107 of method 100 could be hazardous in the case of an unconcealed object, the method can be aborted in step 106. If the comparison shows, for example, a value of the intensity of the received first radiation that is outside the tolerance range of the predefined value of the intensity, this can be attributed to the emitted first radiation not having been diffusely scattered or diffusely reflected, but, rather, directionally reflected. In particular an excessively low value or even the lack of reception of the first radiation can indicate that the emitted first radiation has been directionally reflected. Since the emission of detection radiation according to step 107 of method 100 could be hazardous in the case of a directed reflection, the method can be aborted in step 106.

If it is determined in step 105 that the at least one ascertained value corresponds to the predefined value, the method can be continued in step 107. In an example, if it is determined in step 105 that the at least one ascertained value is in the tolerance range of the predefined value, the method can be continued in step 107.

The first part of method 100 can optionally also include steps 111 and 112. Optional step 111 takes place directly after start 101 of method 100. The surroundings are detected in step 111. The detection of the surroundings and the recognition of obstacles can take place using the LIDAR device itself. Alternatively or additionally, the detection of the surroundings and the recognition of obstacles can take place using at least one further sensor device that is installed in a vehicle. If obstacles are recognized in subsequent step 112, based on the detected surroundings, and a concealed area is recognized based on the obstacles, the method is continued in step 102. If no obstacles and no concealed area are recognized in step 112, based on the detected surroundings, the method can be aborted in step 113. However, if obstacles, but no concealed area, are/is recognized in step 112 based on the detected surroundings, the method can be aborted in step 113.

Steps 101-106 and steps 111-113 of method 100 chronologically precede steps 107-110. The chronologically preceding time period, in particular the time interval between the first part of method 100 and the second part of method 100, can be small. The emission of the first radiation and the emission of the detection radiation can take place within a small time interval. The small time interval can be in the range of milliseconds. The small time interval can be in the range of 50 ms to 100 ms, for example.

As described above, following step 105, method 100 can continue with step 107. Detection radiation is emitted in a predefined direction in step 107 for illuminating a scattering surface, using at least one transmitting unit. The power of the detection radiation emitted in step 107 can be different from the power of the first radiation emitted in step 102. The intensities of the laser pulses of the first radiation emitted in step 102 can be lower than the intensities of the laser pulses of the detection radiation emitted in step 107. In particular, the first radiation emitted in step 102 can be safe to the eyes. Additionally or alternatively, the wavelength of the emitted detection radiation can be different from the wavelength of the first radiation emitted in step 102.

FIG. 2B illustrates the second part of method 100 from step 107 up to and including step 110. The same vehicle 201 with the same LIDAR device 300 is shown as in FIG. 2A, except with a small time interval, i.e., at a slightly later point in time. Detection radiation 207 is emitted in a predefined direction using a transmitting unit. The same surface of the same area 204 can be illuminated with emitted detection radiation 207 as with emitted first radiation 211. Although not shown here, emitted detection radiation 207 can also be used to illuminate a surface of a second area that partially overlaps or preferably closely adjoins area 204. Scattering surface 204 is situated in a visual field of concealed object 205. Emitted detection radiation 207 is scattered by scattering surface 204. A portion of the scattered detection radiation can illuminate concealed object 205 in area 202 due to the high intensity of the laser pulses. This is depicted in FIG. 2B by marked arrow 209. At least a portion of scattered detection radiation 209 is reflected, in particular diffusely reflected, from object 205 to image area 206. This is in turn depicted by arrow 210-1. As shown in FIG. 2B, image area 206 can be spaced apart from area 204. As indicated by arrow 210-2, at least a portion of this reflected detection radiation can be received by LIDAR device 300 of vehicle 201.

This corresponds to step 108 of method 100 from FIG. 1. The reception of the reflected detection radiation from an image area can take place using a receiving unit. The concealed object is detected in step 109 of method 100 based on the received detection radiation, using at least one evaluation unit. For this purpose, the received detection radiation is evaluated in particular according to a time-of-flight method. In this regard, reference is made to p. 11, 1. 17-p. 14, 1. 24 of WO 2016/063028, the content of which is incorporated by reference herein in its entirety. The evaluation can in particular be based on the evaluation described in WO 2016/063028. Information can be generated during the evaluation. The presence of least one concealed object can be detected and generated as a piece of information. The concealed object can be a nonmoving or a moving object. The size, shape, and alternatively or additionally the movement of at least one moving concealed object can be detected and generated as a piece of information.

The generated information can be displayed on a display unit. The display unit can be situated in a vehicle, for example. Information concerning the concealed object can thus be displayed to an occupant of the vehicle. Alternatively or additionally, the generated information can be transmitted to a control unit. This can be, for example, a control unit of a driver assistance system of a vehicle. This also can be, for example, a control unit of an autonomous vehicle. The generated information can be utilized by the control unit.

Method 100 from FIG. 1 ends with step 110.

FIG. 3 shows LIDAR device 300 for detecting a concealed object, as an exemplary embodiment. LIDAR device 300 includes transmitting unit 307-1. Transmitting unit 307-1 can include laser 301-1. Transmitting unit 307-1 can also include at least one optical component 304-1. An optical component can be a refractive optical element, a diffractive optical element, or a mirror, for example. Transmitting unit 307-1 can also include a sampling unit 303-1. It is possible to scan the surroundings of LIDAR device 300 using sampling unit 303-1. LIDAR device 300 also includes at least receiving unit 308-1. Receiving unit 308-1 can include detector 302-1. Receiving unit 308-1 can also include at least one optical component 304-1. Receiving unit 308-1 can also include a sampling unit 303-1. In the example shown, transmitting unit 307-1 and receiving unit 308-1 include the same optical component 304-1 and the same sampling unit 303-1. Alternatively (not shown here), transmitting unit 307-1 can include an optical component that is different from a second optical component of receiving unit 308-1. Alternatively (not shown), transmitting unit 307-1 can include a sampling unit that is different from a second sampling unit of receiving unit 308-1. LIDAR device 300 also includes control unit 305. Control unit 305 can be configured for controlling laser 301-1. Control unit 305 can be configured for controlling detector 302-1. Control unit 305 can be configured for controlling a sampling unit 303-1. LIDAR device 300 also includes an evaluation unit 306. Evaluation unit 306 can obtain data transmitted from detector 302-1. Evaluation unit 306 can be connected to control unit 305.

Transmitting unit 307-1 is designed for emitting detection radiation in a predefined direction for illuminating a scattering surface. Transmitting unit 307-1 can also be designed for emitting a first radiation in the predefined direction for illuminating the scattering surface. Receiving unit 308-1 is designed for receiving reflected detection radiation from an image area. The reflected detection radiation is the detection radiation that has been reflected from the concealed object to the image area. Receiving unit 308-1 can also be designed for receiving a first radiation that is scattered on the surface. Data are generated by the receiving unit based on the received reflected detection radiation. These data are transmitted to the evaluation unit. Data are generated by the receiving unit based on the received first radiation. These data are transmitted to the evaluation unit. Evaluation unit 306 is designed for detecting the concealed object based on the received detection radiation. The evaluation unit can also be designed for ascertaining at least one value of the received first radiation.

In one variant, LIDAR device 300 can include at least one second transmitting unit in addition to first transmitting unit 307-1. This is transmitting unit 307-2 in FIG. 3. Transmitting unit 307-2 can include laser 301-2.

First transmitting unit 307-1 can be designed for emitting the detection radiation, and second transmitting unit 307-2 can be designed for emitting the first radiation. In addition, the LIDAR device can include a second receiving unit in addition to first receiving unit 308-1. This is receiving unit 308-2 in FIG. 3. Receiving unit 308-2 can include detector 302-2. First receiving unit 308-1 can be designed for receiving the reflected detection radiation, and second receiving unit 308-2 can be designed for receiving the first radiation scattered on the surface. Similarly as for transmitting unit 307-1 and receiving unit 308-1, transmitting unit 307-2 and receiving unit 308-2 can also include the same at least one optical component 304-2. Transmitting unit 307-2 and receiving unit 308-2 can also include the same sampling unit 303-2. Alternatively (not shown here), transmitting unit 307-2 can include an optical component that is different from a second optical component of receiving unit 308-2. Alternatively (not shown here), transmitting unit 307-2 can include a sampling unit that is different from a second sampling unit of receiving unit 308-2. Control unit 305 of LIDAR device 300 can be configured for controlling laser 301-2. Control unit 305 can be configured for controlling detector 302-2. Control unit 305 can be configured for controlling sampling unit 303-2. Evaluation unit 306 can obtain data transmitted from detector 302-2.

In one variant, LIDAR device 300 can be connected to a sensor device 309. Sensor device 309 can be, for example, a further sensor device that is installed in a vehicle. For example, the surroundings can be detected and obstacles recognized using sensor device 309.

What is claimed is:

1. A method of a LIDAR device for detecting a concealed object that is concealed by an obstacle from a visual field of the LIDAR device, the method comprising:
in a first detection process:
emitting a first radiation in a predefined direction for illuminating and being scattered on a scattering surface;
receiving a reflection of the first radiation; and
ascertaining at least one value of the received reflection of the first radiation; and
subsequent to the first detection process, execute a second detection process based on the at least one value, wherein the second detection process includes:
emitting detection radiation in the predefined direction for illuminating and being scattered on the scattering surface, the scattering surface being situated in a visual field of the concealed object;
receiving from an image area reflected detection radiation that is a reflection of the detection radiation from the concealed object to the image area; and
detecting the concealed object based on the received detection radiation.

2. The method of claim 1, wherein the first detection process further includes comparing the ascertained at least one value to at least one predefined value, and execution of the second detection process is based on a result of the comparison.

3. The method of claim 1, wherein the ascertained at least one value includes one or both of (a) a value of an intensity of the received first radiation and (b) a value of a distance of an unconcealed object in the visual field of the LIDAR device.

4. The method of claim 1, wherein a power of the emitted detection radiation is different than a power of the emitted first radiation.

5. The method of claim 1, wherein a wavelength of the emitted detection radiation is different than a wavelength of the emitted first radiation.

6. The method of claim 1, wherein:
the method further comprises, prior to the first detection process, performing the following:
detecting surroundings of the LIDAR device; and
based on the detected surroundings, recognizing obstacles and an area concealed by the obstacles; and
the emission of the first radiation is performed based on the recognition of the obstacles and the area concealed by the obstacles.

7. A non-transitory computer-readable medium on which are stored instructions that are executable by a processor of a LIDAR device and that, when executed by the processor, cause the processor to perform a method for detecting a concealed object that is concealed by an obstacle from a visual field of the LIDAR device, the method comprising:
in a first detection process:
controlling the LIDAR device to emit a first radiation in a predefined direction for illuminating and being scattered on a scattering surface;
obtaining a received reflection of the first radiation; and
ascertaining at least one value of the received reflection of the first radiation; and
subsequent to the first detection process, execute a second detection process based on the at least one value, wherein the second detection process includes:
controlling the LIDAR device to emit detection radiation in the predefined direction for illuminating and being scattered on the scattering surface, the scattering surface being situated in a visual field of the concealed object;
obtaining reflected detection radiation received from an image area and that is a reflection of the detection radiation from the concealed object to the image area; and
detecting the concealed object based on the received detection radiation.

8. A LIDAR device for detecting a concealed object that is concealed by an obstacle from a visual field of the LIDAR device, the LIDAR device comprising:
at least one transmitter;
at least one receiver; and
at least one processor;
wherein the LIDAR device is configured to:
execute a first detection process in which:
the LIDAR device transmits, via the at least one transmitter, a first radiation in a predefined direction for illuminating and being scattered on a scattering surface;
the LIDAR device receives, via the at least one receiver, a reflection of the first radiation; and
the LIDAR device ascertains, via the at least one processor, at least one value of the received reflection of the first radiation;
subsequent to the first detection process, execute a second detection process based on the at least one value; and
the second detection process includes:
emitting, via the at least one transmitter, detection radiation in the predefined direction for illuminating and being scattered on the scattering surface, the scattering surface being situated in a visual field of the concealed object;
receiving, via the at least one receiver and from an image area, reflected detection radiation that is a reflection of the detection radiation from the concealed object to the image area; and
detecting, via the at least one processor, the concealed object based on the received detection radiation.

9. The LIDAR device of claim 8, wherein the at least one transmitter includes a first transmitter for the emission of the first radiation and a second transmitter for the emission of the detection radiation.

10. The LIDAR device of claim 8, wherein the at least one receiver includes a first receiver for the receipt of the reflection of the first radiation and a second receiver for the receipt of the reflected detection radiation.
